(19) United States
(12) Patent Application Publication
(10) Pub. No.: US 2026/0307530 A1
(43) Pub. Date: Oct. 8, 2026

(54) ELECTRIC VEHICLE CHARGING SYSTEM WITH CONCURRENT MULTI-MODE V2X SUPPORT

(71) Applicant: Solution X Co., Ltd., Seoul (KR)

(72) Inventors: Se Wan CHOI, Seoul (KR); Chang Seop LEE, Seoul (KR); Minh-Khai NGUYEN, Detroit, MI (US)

(73) Assignee: Solution X Co., Ltd., Seoul (KR)

(21) Appl. No.: 19/312,289

(22) Filed: Aug. 27, 2025

(30) Foreign Application Priority Data
Apr. 7, 2025 (KR) 10-2025-0044501

(51) Int. Cl. B60L 55/00; B60L 53/62; H02J 7/00

(52) U.S. Cl. CPC B60L 55/00; B60L 53/62; H02J 7/855

(57) ABSTRACT

An electric vehicle charging system includes: a relay box with a plurality of AC power terminals disposed therein, the AC power terminals having power input/output pathways that are changed depending on the on/off status of built-in relays; a plurality of on-board chargers that support bidirectional power conversion between an electric vehicle battery and the relay box; and a control part that supports charging and V2X concurrently through the AC power terminals by controlling the direction of power conversion of each on-board charger and the on/off status of the relays.

### CROSS REFERENCE TO RELATED APPLICATION

This application claims the benefit of and priority to Korea Patent Application No. 10-2025-0044501, filed on Apr. 7, 2025, the entire contents of which are hereby incorporated herein by reference.

### FIELD OF TECHNOLOGY

The present disclosure relates to an electric vehicle charging system.

### BACKGROUND

V2X(Vehicle-to-Everything) is a technology that supplies electric power stored in a vehicle battery to an external load, and includes V2G(Vehicle-to-Grid) which supplies electric power from a vehicle to a grid, V2H(Vehicle-to-Home) which supplies electric power from a vehicle to a home, and V2L(Vehicle-to-Load) which directly supplies electric power from a vehicle to an individual external device or load.

With the widespread adoption of electric vehicles (EV), there is growing interest and demand for V2X technology, which uses vehicle batteries not only as a driving energy source but also utilizes them by connecting them to an external load and a power grid.

However, most of the V2X technologies developed so far have the limitation of operating in only one mode at a time. For example, electric vehicles typically supply power to an external load only when they are not charging, or switch to V2H operation after completing V2G operation.

Meanwhile, in today's diverse industrial and business environments, there is a growing number of cases where an electric vehicle is required to operate in two or more modes concurrently. Particularly in various environments such as camping sites, construction sites, military vehicles, and disaster response sites, there is an increasing need to continuously supply power to an external load even while charging. Additionally, in areas with insufficient electric vehicle charging infrastructure, it is becoming necessary to mitigate the lack of charging infrastructure by supplying power to another electric vehicle (V2V) or electronic device during charging.

Currently, electric vehicles primarily use an On-board Charger (OBC) to convert AC power from an AC power grid into DC power to charge the battery. However, conventional OBC designs have limitations in simultaneously performing both charging and discharging modes, and there are difficulties in supporting external loads as well or supplying dual voltages of 120V and 240V simultaneously. Most systems require a DC-AC inverter or additional hardware, which increases system complexity and cost.

### SUMMARY

Against this background, in one aspect, the present disclosure is directed to providing an integrated electric vehicle charging system that can reliably perform various operation modes such as V2G, V2H, and V2L in parallel while charging the electric vehicle. In another aspect, the present disclosure is directed to providing an electric vehicle charging system that can simultaneously output voltages of 120V and 240V without the addition of a DC-AC inverter or without complex hardware configurations, thereby minimizing system complexity and cost. In yet another aspect, the present disclosure is directed to providing a single integrated electric vehicle charging system capable of reliably handling high power while flexibly switching between charging and discharging or performing both charging and discharging simultaneously.

To accomplish the foregoing aspects, one embodiment of the present disclosure provides an electric vehicle charging system including: a relay box with a plurality of AC power terminals disposed therein, the AC power terminals having power input/output pathways that are changed depending on the on/off status of built-in relays; a plurality of on-board chargers that support bidirectional power conversion between an electric vehicle battery and the relay box; and a control part that supports charging and V2X concurrently through the AC power terminals by controlling the direction of power conversion of each on-board charger and the on/off status of the relays.

A plurality of AC power terminal groups each including at least two AC power terminals may be formed in the relay box, wherein the control part may control connections between the plurality of AC power terminal groups and the plurality of on-board chargers by controlling the on/off status of the relays.

In a first combination mode, the electric vehicle battery may be charged with AC power via a first on-board charger, the AC power being inputted through a first AC power terminal group, and the electric vehicle battery's power may be discharged to a second AC power terminal group via a second on-board charger.

In a second combination mode, a first on-board charger may be connected to a first AC power terminal group, a second on-board charger may be connected to a second AC power terminal group, and the first AC power terminal group and the second AC power terminal group each may operate in one of V2G, V2L, and V2H modes.

The first on-board charger and the second on-board charger may control the voltage outputted through each AC power terminal group to differ in voltage level.

In a third combination mode, the plurality of on-board chargers may simultaneously charge the electric vehicle battery while operating in parallel, by converting the power inputted into one AC power terminal group.

In a split-phase mode, one AC power terminal group may include three AC power terminals, one AC power discharged via one on-board charger may be outputted to an AC power first terminal and an AC power second terminal, another AC power discharged via another on-board charger may be outputted to an AC power third terminal and an AC power second terminal, and the one AC power and the another AC power may be 180 degrees out of phase.

In a single-phase dual-voltage power mode, one AC power terminal group may include three AC power terminals, one AC power discharged via one on-board charger may be outputted to an AC power first terminal and an AC power second terminal, another AC power discharged via another on-board charger may be outputted to an AC power third terminal and an AC power second terminal, and the voltage level of the another AC power may be twice the voltage level of the one AC power.

A first AC power terminal group may include a first AC power first terminal and a first AC power second terminal, and a second AC power terminal group may include a second AC power first terminal and a second AC power second terminal, wherein the first AC power second terminal and the second AC power second terminal may be connected to a common terminal, and a first relay may be positioned between the first AC power first terminal and an input node of a first on-board charger, a second relay may be positioned between the second AC power first terminal and an input node of a second on-board charger, and a third relay may be positioned between the input node of the first on-board charger and the input node of the second on-board charger.

The second AC power terminal group may further include a second AC power third terminal, and a fourth relay may be positioned between the second AC power third terminal and the input node of the first on-board charger.

A power decoupling circuit may be positioned between the plurality of on-board chargers and the electric vehicle battery, an input filter circuit may be positioned between the relay box and the plurality of on-board chargers, and an output filter circuit may be positioned between the plurality of on-board chargers and the electric vehicle battery.

The rated power of each on-board charger may be substantially the same.

Another embodiment of the present disclosure provides an electric vehicle charging system including: a relay box with a plurality of AC power terminals disposed therein, the AC power terminals having power input/output pathways that change depending on the on/off status of built-in relays; a first on-board charger that supports bidirectional power conversion between an electric vehicle battery and the relay box; a second on-board charger that supports bidirectional power conversion between the electric vehicle battery and the relay box and has a lower rated power than the first on-board charger; and a control part that supports charging and V2X concurrently through the AC power terminals by controlling the direction of power conversion of each on-board charger and the on/off status of the relays.

A plurality of AC power terminal groups each including at least two AC power terminals may be formed in the relay box, wherein the control part may control connections between the plurality of AC power terminal groups and the plurality of on-board chargers by controlling the on/off status of the relays.

The first on-board charger may operate in a charging mode, and the second on-board charger may operate in a discharging mode, wherein the AC power supplied to the first on-board charger and the AC power outputted by the second on-board charger may be controlled to differ in voltage level.

As described above, according to the present disclosure, various operation modes such as V2G, V2H, and V2L can be reliably performed while an electric vehicle is performing charging, thereby maximizing the utilization of the vehicle's battery. Furthermore, according to the present disclosure, the output of voltages of 120V and 240V can be supported concurrently without an additional DC-AC inverter or complex hardware, thereby reducing system complexity and lowering manufacturing and operating costs. In addition, according to the present disclosure, a single integrated structure is provided which is capable of flexibly switching between charging and discharging and reliably handling high power, thereby enhancing system reliability and efficiency.

### BRIEF DESCRIPTION OF THE DRAWINGS

FIG. 1 is a configuration diagram of an electric vehicle charging system according to one embodiment.

FIG. 2A is a view showing a power flow in the first combination mode according to one embodiment.

FIG. 2B is a view showing a power flow in the second combination mode according to one embodiment.

FIG. 2C is a view showing a power flow in the third combination mode according to one embodiment.

FIG. 2D is a view showing a power flow in the fourth combination mode according to one embodiment.

FIG. 3 is a configuration diagram of an electric vehicle charging system including a detailed configuration of a relay box according to one embodiment.

FIG. 4 is a view showing an electric vehicle charging system according to one embodiment that is performing G2V and V2L simultaneously.

FIG. 5 is a view showing an electric vehicle charging system according to one embodiment that is performing V2H and V2L simultaneously.

FIG. 6 is a view showing an electric vehicle charging system according to one embodiment that is performing V2G and V2L simultaneously.

FIG. 7 is a view showing an electric vehicle charging system according to one embodiment that is performing G2V using a plurality of on-board chargers.

FIG. 8 is a view showing an electric vehicle charging system according to one embodiment that is performing V2H using a plurality of on-board chargers.

FIG. 9 is a view showing an electric vehicle charging system according to one embodiment that is performing V2G using a plurality of on-board chargers.

FIG. 10A is a view showing an electric vehicle charging system according to one embodiment that is performing a V2L split-phase mode.

FIG. 10B is a view showing an output waveform of an AC power terminal in the mode of FIG. 10A.

FIG. 11A is a view showing an electric vehicle charging system according to one embodiment that is performing a V2L single-phase dual-voltage power mode.

FIG. 11B is a view showing an output waveform of an AC power terminal in the mode of FIG. 11A.

FIG. 12 is a view showing an electric vehicle charging system according to another embodiment that is performing G2V.

FIG. 13 is a view showing an electric vehicle charging system according to another embodiment that is performing G2V and V2L simultaneously.

### DETAILED DESCRIPTION

Hereinafter, some embodiments of the present disclosure are described in detail with reference to the accompanying drawings. With regard to the reference numerals of the components of the respective drawings, it should be noted that the same reference numerals are assigned to the same components even when the components are shown in different drawings. In addition, in describing the present disclosure, detailed descriptions of well-known configurations or functions have been omitted in order not to obscure the gist of the present disclosure.

In addition, terms such as “1st”, “2nd”, “A”, “B”, “(a)”, “(b)”, or the like may be used in describing the components of the present disclosure. These terms are intended only for distinguishing a corresponding component from other components, and the nature, order, or sequence of the corresponding component is not limited to the terms. In the case where a component is described as being “coupled”, “combined”, or “connected” to another component, it should be understood that the corresponding component may be directly coupled or connected to another component or that the corresponding component may also be “coupled”, “combined”, or “connected” to the component via another component provided therebetween.

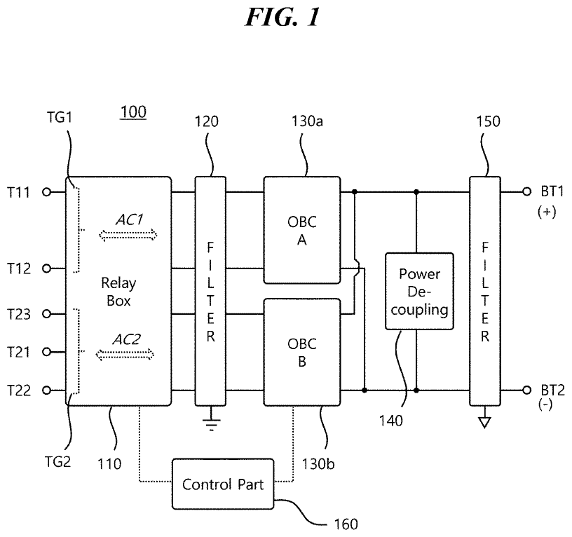

FIG. 1 is a configuration diagram of an electric vehicle charging system according to one embodiment.

Referring to FIG. 1, the electric vehicle charging system 100 may include a relay box 110, a plurality of on-board chargers 130a and 130b, and a control part 160.

AC power terminals T11, T12, T21, T22, and T23 may be disposed on one side of the electric vehicle charging system 110, and battery terminals BT1 and BT2 may be disposed on the other side. A grid, i.e., a commercial power grid, may be connected to the AC power terminals T11, T12, T21, T22, and T23, an internal power grid of one household may be connected thereto, and an external device or load may be connected thereto. Also, an electric vehicle battery may be connected to the battery terminals BT1 and BT2.

A plurality of AC power terminal groups TG1 and TG2 may be formed on one side of the relay box 110. Also, each AC power terminal group may include at least two AC power terminals. For example, the first AC power terminal group TG1 may include a first AC power first terminal T11 and a first AC power second terminal T12. Also, the second AC power terminal group TG2 may include a second AC power first terminal T21, a second AC power second terminal T22, and a second AC power third terminal T23.

The power inputted or outputted through the first AC power terminal group TG1 may be referred to as first AC power AC1, and the power inputted or outputted through the second AC power terminal group TG2 may be referred to as second AC power AC2. For example, AC power of 240V for charging the electric vehicle battery may be inputted through the first AC power terminal group TG1, and such AC power may be the first AC power. Meanwhile, AC power of 120V for a load may be outputted through the second AC power terminal group TG2, and such AC power may be the second AC power.

The first AC power AC and the second AC power may be input power directed toward the electric vehicle battery or output power directed outward from the electric vehicle battery.

The first AC power and the second AC power may be single-phase power, split-phase power, or single-phase dual-voltage power.

For single-phase power, two AC power terminals may function as L1 phase and N phase or L2 phase, respectively. For split-phase power or single-phase dual-voltage power, three AC power terminals may function as L1 phase, N phase, and L2 phase.

The other side of the relay boxy 110 may be connected to the on-board charges 130a and 130b. Also, relays may be incorporated within the relay box 110 to control connections between the AC power terminals T11, T12, T21, T22, T23 on one side and the on-board chargers 130a and 130b on the other side.

Power input/output pathways for the AC power terminals T11, T12, T21, T22, and T23 may change depending on the on/off status of the relays. For example, the first AC power AC1 may flow to the first AC power terminal group TG1, and the second AC power AC2 may flow to the second AC power terminal group TG2, depending on the on/off status of the relays.

The first on-board charger 130a may form a flow of the first AC power AC1, and the second on-board charger 130b may form a flow of the second AC power AC2. In some embodiments, the rated power of the first on-board charger 130a and the rated power of the second on-board charger 130b may be substantially the same.

The first on-board charger 130a and the second on-board charger 130b may support bidirectional power conversion between the electric vehicle battery and the relay box. The first on-board charger 130a and the second on-board charger 130b may convert the power supplied from the AC power terminals T11, T12, T21, T22, and T23 and deliver it to the electric vehicle battery. In this case, the AC power AC1 and AC2 is charging power and flows from the AC power terminals T11, T12, T21. T22, and T23 toward the electric vehicle battery. Conversely, the first on-board charger 130a and the second on-board charger 130b may convert the power stored in the electric vehicle battery and supply it to the AC power terminals T11, T12, T21, T22, and T23. In this case, the AC power AC1 and AC2 is discharging power and flows from the electric vehicle battery to the AC power terminals T11, T12, T21, T22, and T23.

The electric vehicle charging system 100 may further include an input filter circuit 120, a power decoupling circuit 140, and an output filter circuit 150. Here, the input filter circuit 120 may be positioned between the relay box 110 and the plurality of on-board chargers 130a and 130b, and the output filter circuit 150 may be positioned between the plurality of on-board chargers 130a and 130b and the electric vehicle battery. The power decoupling circuit 140 may also be positioned between the plurality of on-board chargers 130a and 130b and the electric vehicle battery.

Meanwhile, the control part 160 may control the direction of power conversion of each on-board charger 130a and 130b and the on/off status of the relays. If the direction of flow from the AC power terminals to the electric vehicle battery is referred to as a first direction, and the direction of flow from the electric vehicle battery to the AC power terminals is referred to as a second direction, then the control part 160 may control the first on-board charger 130a such that the first AC power AC1 flows in the first direction and control the second on-board charger 130b such that the second AC power AC2 flows in the second direction. Additionally, the control part 160 may control the relays so that the first AC power AC1 flows to the first AC power terminal group TG1 and the second AC power AC2 flows to the second AC power terminal group TG2.

The control part 160 may enable various combination modes through such control.

A first combination mode allows the first AC power AC1 to flow in the first direction through the first AC power terminal group TG1 and allows the second AC power AC2 to flow in the second direction through the second AC power terminal group TG2. In the first combination mode, the electric vehicle battery may be charged with the first AC power AC1 inputted through the first AC power terminal group TG1, via the first on-board charger 130a. At the same time, the electric vehicle battery's power may be discharged to the second AC power terminal group TG2 via the second on-board charger 130b.

A second combination mode allows the first AC power AC1 to flow in the first direction through the first AC power terminal group TG1 and allows the second AC power AC2 to flow in the second direction through the second AC power terminal group TG2. In the second combination mode, the electric vehicle battery's power may be discharged to the first AC power terminal group TG1 via the first on-board charger 130a, and at the same time, the electric vehicle's power may be discharged to the second AC power terminal group TG2 via the second on-board charger 130b. In this case, the first AC power terminal group TG1 and the second AC power terminal group TG2 each may operate in one of V2G, V2L, and V2H modes.

In the second combination mode, the first on-board charger 130a and the second on-board charger 130b may control the voltage outputted through each of the AC power terminal groups TG1 and TG2 to differ in voltage level. For example, the first on-board charger 130a may control the output voltage to have a voltage level of 240V, while the second on-board charger 130b may control the output voltage to have a voltage level of 120V. This voltage level control allows for the creation of sub-combinations within each combination mode.

In a third combination mode, a plurality of on-board chargers 130a and 130b may simultaneously charge the electric vehicle battery while operating in parallel, by converting the power inputted into one AC power terminal group, e.g., the first AC power terminal group TG1.

In a fourth combination mode, a plurality of on-board chargers 130a and 130b may discharge power from the electric vehicle battery while operating in parallel, so as to output the power to one AC power terminal group, e.g., the first AC power terminal group TG1.

In a fifth combination mode, also referred to as a split-phase mode, one AC power terminal group may include three AC power terminals. For example, the second AC power terminal group TG2 may include three AC power terminals T21, T22, and T23. One AC power discharged via one on-board charger may be outputted to an AC power first terminal (e.g., T21) and an AC power second terminal (e.g., T22), whereas another AC power discharged via another on-board charger may be outputted to an AC power third terminal (e.g., T23) and an AC power second terminal (e.g., T22). In this case, the one AC power and the another AC power may be 180 degrees out of phase. Such power phase control may serve to form sub-combinations within each combination mode.

In a sixth combination mode, also referred to as a single-phase dual-voltage power mode, one AC power terminal group may include three AC power terminals. For example, the second AC power terminal group TG2 may include three AC power terminals T21, T22, and T23. One AC power discharged via one on-board charger may be outputted to an AC power first terminal (e.g., T21) and an AC power second terminal (e.g., T22), whereas another AC power discharged via another on-board charger may be outputted to an AC power third terminal (e.g., T23) and a AC power second terminal (e.g., T22). In this case, the voltage level of the another AC power may be twice the voltage level of the one AC power.

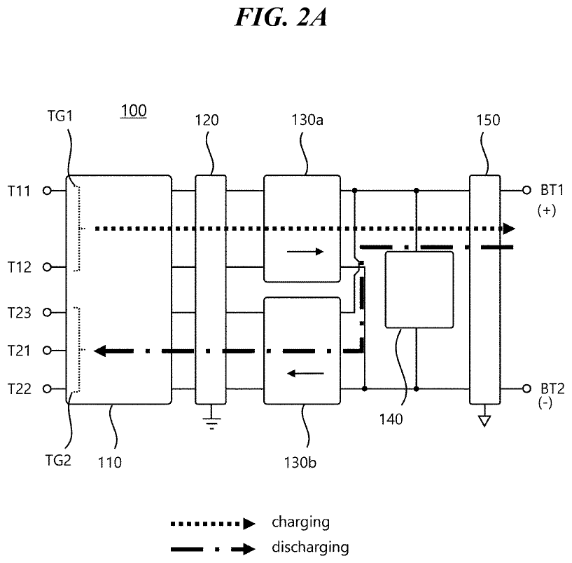

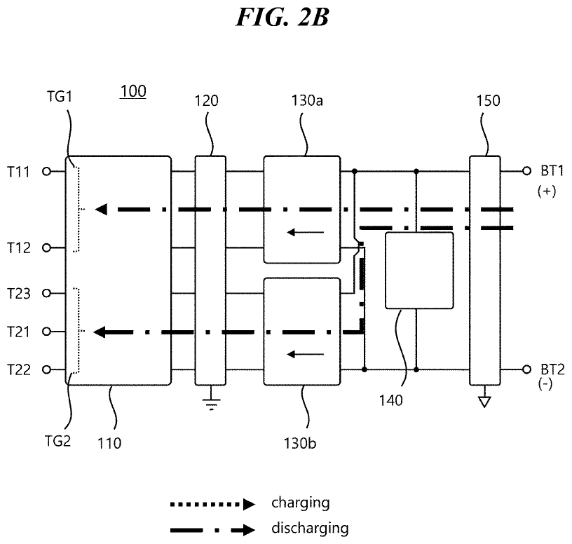

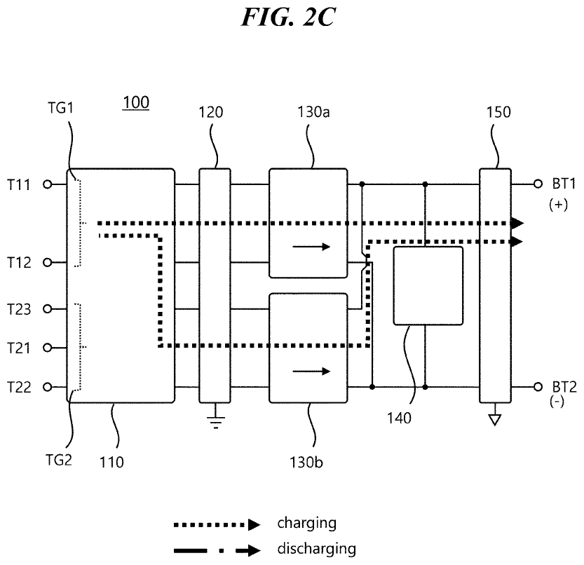

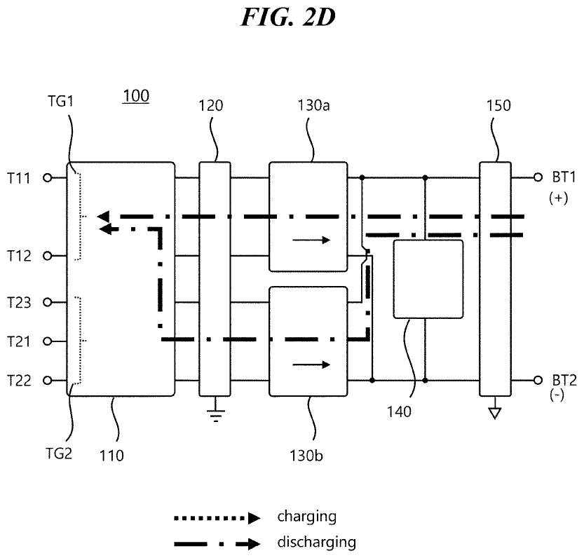

FIG. 2A is a view showing a power flow in the first combination mode according to one embodiment.

Referring to FIG. 2A, the relay box 110 may allow the first AC power formed in the first on-board charger 130a to flow to the first AC power terminal group TG1. In addition, the relay box 110 may allow the second AC power formed in the second on-board charger 130b to flow to the second AC power terminal group TG2.

The first on-board charger 130a may allow the first AC power to flow in the direction for charging the electric vehicle battery, and the second on-board charger 130b may allow the second AC power to flow in the direction for discharging the electric vehicle battery.

In the first combination mode, the electric vehicle charging system may charge the electric vehicle battery and at the same time may provide operation modes such as V2G, V2H, and V2L.

FIG. 2B is a view showing a power flow in the second combination mode according to one embodiment.

Referring to FIG. 2B, the relay box 110 may allow the first AC power formed in the first on-board charger 130a to flow to the first AC power terminal group TG1. Also, the relay box 110 may allow the second AC power formed in the second on-board charger 130b to flow to the second AC power terminal group TG2.

The first on-board charger 130a may allow the first AC power to flow in the direction for discharging the electric vehicle battery, and the second on-board charger 130b may allow the second AC power to flow in the direction for discharging the electric vehicle battery.

In the second combination mode, the electric vehicle charging system may concurrently provide two out of the operation modes V2G, V2H, and V2L.

FIG. 2C is a view showing a power flow in the third combination mode according to one embodiment.

Referring to FIG. 2C, the relay box 110 may allow the first AC power formed in the first on-board charger 130a to flow to the first AC power terminal group TG1. Also, the relay box 110 may allow the second AC power formed in the second on-board charger 130b to also flow to the first AC power terminal group TG1.

The first on-board charger 130a may allow the first AC power to flow in the direction for charging the electric vehicle battery, and the second on-board charger 130b also may allow the second AC power to flow in the direction for charging the electric vehicle battery.

In the third combination mode, the electric vehicle charging system may charge the electric vehicle battery at twice the rated capacity of an on-board charger. For example, if one on-board charger has a rated capacity of 9.6 kW, the electric vehicle charging system 100 may charge the electric vehicle battery at a combined rated capacity of 19.2 kW.

FIG. 2D is a view showing a power flow in the fourth combination mode according to one embodiment.

Referring to FIG. 2D, the relay box 110 may allow the first AC power formed in the first on-board charger 130a to flow to the first AC power terminal group TG1. Also, the relay box 110 may allow the second AC power formed in the second on-board charger 130b to also flow to the first AC power terminal group TG1.

The first on-board charger 130a may allow the first AC power to flow in the direction for discharging the electric vehicle battery, and the second on-board charger 130b also may allow the second AC power to flow in the direction for discharging the electric vehicle battery.

In the fourth combination mode, the electric vehicle charging system 100 may charge the electric vehicle battery at twice the rated capacity of an on-board charger. For example, the electric vehicle charging system 100 may provide power at a rated capacity of 19.2 kW when implementing V2H.

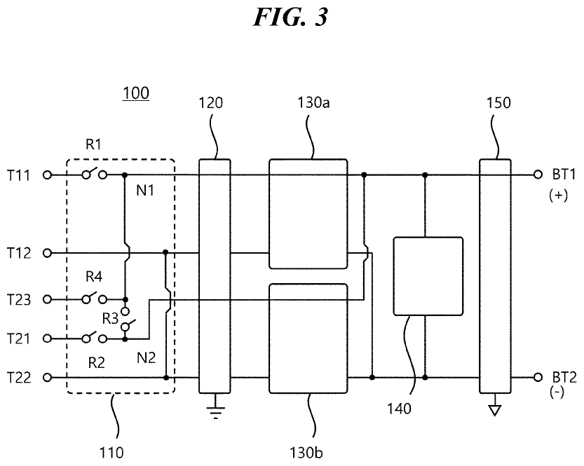

FIG. 3 is a configuration diagram of an electric vehicle charging system including a detailed configuration of a relay box according to one embodiment.

Referring to FIG. 3, a plurality of AC power terminal groups TG1 and TG2 may be formed on one side of the relay box 110. The first AC power terminal group TG1 may include a first AC power first terminal T11 and a first AC power second terminal T12. The second AC power terminal group TG2 may include a second AC power first terminal T21, a second AC power second terminal T22, and a second AC power third terminal T23.

The first AC power second terminal T12 and the second AC power second terminal T22 may be connected to a common terminal. Here, the common terminal may be a grounding terminal in a grounded state.

On the other side of the relay box 110, a first node N1 connected to an input node of the first on-board charger 130a may be formed, and a second node N2 connected to an input node of the second on-board charger 130b may be formed. Here, the input node of the first on-board charger 130a and the first node N1 may be electrically identical nodes, and the input node of the second on-board charger 130b and the second node N2 may be electrically identical nodes.

A first relay R1 may be positioned between the first AC power first terminal T11 and the first node N1, and may connect or disconnect the power flow between the first on-board charger 130a and the first AC power first terminal T11.

A second relay R2 may be between the second AC power first terminal T21 and the second node N2, and may connect or disconnect the power flow between the second on-board charger 130b and the second AC power first terminal T21.

A third relay R3 may be positioned between the first node N1 and the second node N2, and may deliver the power flowing through the first on-board charger 130a to the second AC power terminal group or deliver the power flowing through the second on-board charger 130b to the first AC power terminal group.

A fourth relay R4 may be positioned between the second AC power third terminal T23 and the first node N1.

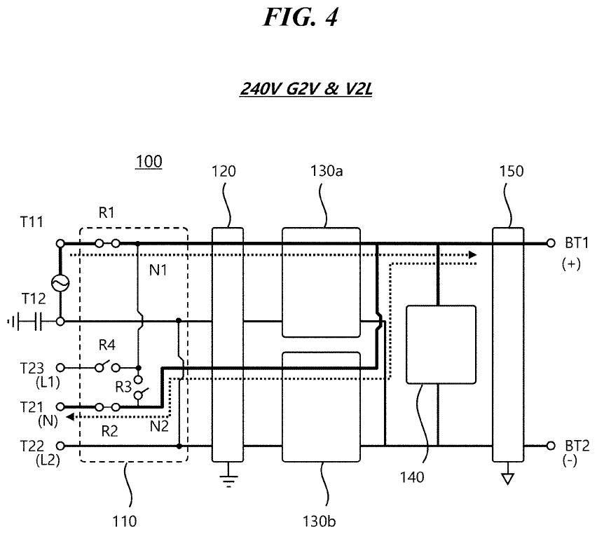

FIG. 4 is a view showing an electric vehicle charging system according to one embodiment that is performing G2V and V2L simultaneously.

Referring to FIG. 4, in the relay box 110, the first relay R1 may be turned on, the second relay R2 may be turned on, the third relay R3 may be turned off, and the fourth relay R4 may be turned off. Depending on the on/off status of these relays, the power flowing through the first on-board charger 130a may be delivered to the first AC power first terminal T11, and the power flowing through the second on-board charger 130b may be delivered to the second AC power first terminal T21.

The control part may run the first on-board charger 130a in a charging mode. The control part may transmit a command value for charging power to the first on-board charger 130a. For example, the control part may transmit a command value to the first on-board charger 130a to charge with 9.6 kW.

The control part may run the second on-board charger 130b in a discharging mode. The control part may transmit an output voltage command value for discharging power to the second on-board charger 130b. For example, the control part may transmit an output voltage command value corresponding to 240V or an output voltage command value corresponding to 120V. Based on the command value, the second on-board charger 130b may discharge power from the electric vehicle battery within a rated power range, for example, up to 9.6 kW.

In the example shown in FIGS. 4, 240V grid power may be connected to the first AC power first terminal T11 and the first AC power second terminal T12, and accordingly, the electric vehicle charging system 100 may support a 240V G2V mode.

A load may be connected to the second AC power first terminal T21 and the second AC power second terminal T22, and accordingly, the electric vehicle charging system 100 may support both G2V and V2L modes. The electric vehicle charging system 100 may supply either 240V or 120V to the load, and accordingly may support V2L up to 9.6 kW at 240V or support V2L up to 9.6 kW at 120V.

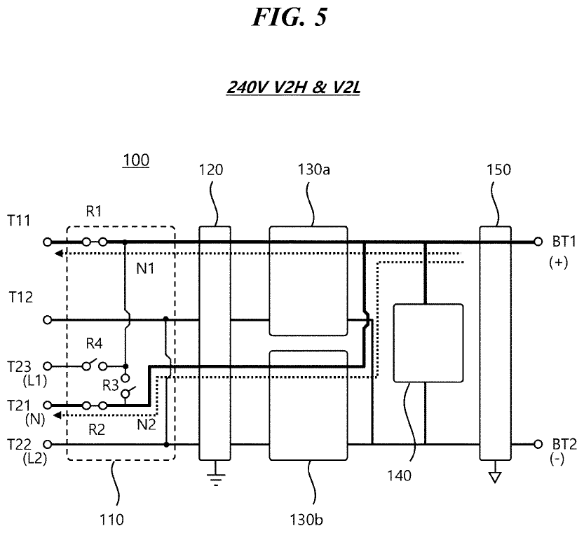

FIG. 5 is a view showing an electric vehicle charging system according to one embodiment that is performing V2H and V2L simultaneously.

Referring to FIG. 5, the first relay R1 in the relay box 110 may be turned on, the second relay R2 may be turned on, the third relay R3 may be turned off, and the fourth relay R4 may be turned off. Depending on the on/off status of these relays, the power flowing through the first on-board charger 130a may be delivered to the first AC power first terminal T11, and the power flowing through the second on-board charger 130b may be delivered to the second AC power first terminal T21.

The control part may run the first on-board charger 130a in the discharging mode. The control part may transmit an output voltage command value for discharging power to the first on-board charger 130a. For example, the control part may transmit an output voltage command value corresponding to 240V. Based on this command value, the first on-board charger 130a may discharge power from the electric vehicle battery within a rated power range, for example, up to 9.6 kW.

The control part may run the second on-board charger 130b in the discharging mode. The control part may transmit an output voltage command value for discharging power to the second on-board charger 130b. For example, the control part may transmit an output voltage command value corresponding to 240V or an output voltage command value corresponding to 120V. Based on this command value, the second on-board charger 130b may discharge power from the electric vehicle battery within a rated power range, for example, up to 9.6 kW.

In the example shown in FIG. 5, a 240V home power grid may be connected to the first AC power first terminal T11 and the first AC power second terminal T12, and accordingly, the electric vehicle charging system 100 may support a 240V V2H mode.

A load may be connected to the second AC power first terminal T21 and the second AC power second terminal T22, and accordingly, the electric vehicle charging system 100 may support both V2H and V2L modes. The electric vehicle charging system 100 may supply either 240V or 120V to the load, and accordingly may support V2L up to 9.6 kW at 240V or support V2L up to 9.6 kW at 120V.

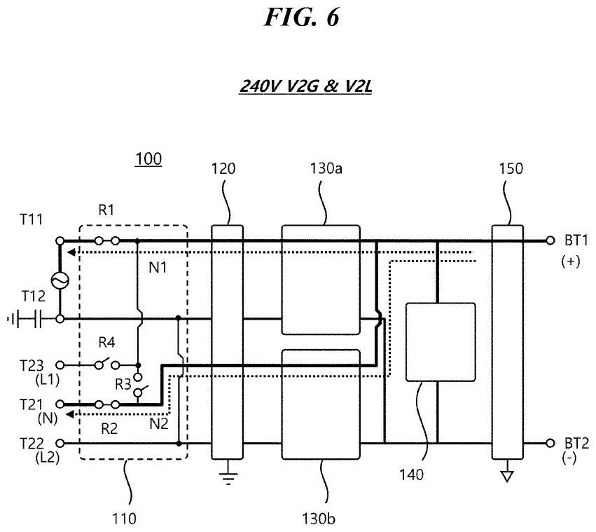

FIG. 6 is a view showing an electric vehicle charging system according to one embodiment that is performing V2G and V2L simultaneously.

Referring to FIG. 6, the first relay R1 in the relay box 110 may be turned on, the second relay R2 may be turned on, the third relay R3 may be turned off, and the fourth relay R4 may be turned off. Depending on the on/off status of these relays, the power flowing through the first on-board charger 130a may be delivered to the first AC power first terminal T11, and the power flowing through the second on-board charger 130b may be delivered to the second AC power first terminal T21.

The control part may run the first on-board charger 130a in the discharging mode. The control part may transmit an output voltage command value for discharging power to the first on-board charger 130a. For example, the control part may transmit an output voltage command value corresponding to 240V. Based on this command value, the first on-board charger 130a may discharge power from the electric vehicle battery within a rated power range, for example, up to 9.6 kW.

The control part may run the second on-board charger 130b in the discharging mode. The control part may transmit an output voltage command value for discharging power to the second on-board charger 130b. For example, the control part may transmit an output voltage command value corresponding to 240V or an output voltage command value corresponding to 120V. Based on this command value, the second on-board charger 130b may discharge power from the electric vehicle battery within a rated power range, for example, up to 9.6 kW.

In the example shown in FIG. 6, a 240V grid, i.e., a commercial power grid, may be connected to the first AC power first terminal T11 and the first AC power second terminal T12, and accordingly, the electric vehicle charging system 100 may support a 240V V2G mode.

A load may be connected to the second AC power first terminal T21 and the second AC power second terminal T22, and accordingly, the electric vehicle charging system 100 may support both V2G and V2L modes. The electric vehicle charging system 100 may supply either 240V or 120V to the load, and accordingly may support V2L up to 9.6 kW at 240V or support V2L up to 9.6 kW at 120V.

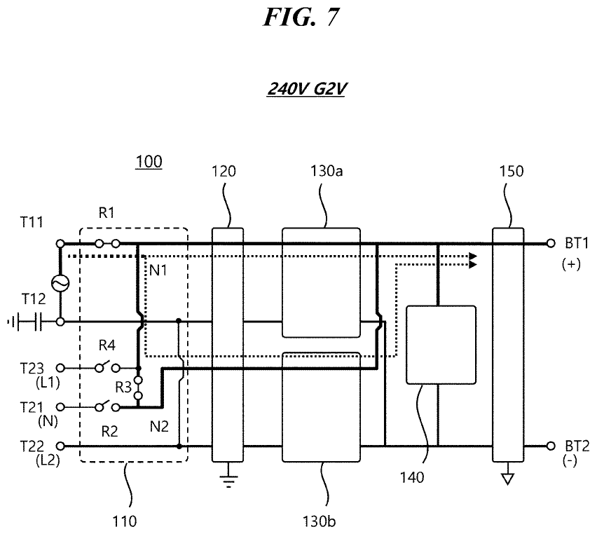

FIG. 7 is a view showing an electric vehicle charging system according to one embodiment that is performing G2V using a plurality of on-board chargers.

Referring to FIG. 7, the first relay R1 in the relay box 110 may be turned on, the second relay R2 may be turned off, the third relay R3 may be turned on, and the fourth relay R4 may be turned off. Depending on the on/off status of these relays, the power flowing through the first on-board charger 130a and the power flowing through the second on-board charger 130b may be delivered to the first AC power first terminal T11.

The control part may run the first on-board charger 130a and the second on-board charger 130b in the charging mode. The control part may transmit a command value for charging power to the first on-board charger 130a and the second on-board charger 130b. For example, the control part may transmit a command value to the first on-board charger 130a to charge with 9.6 kW and transmit a command value to the second on-board charger 130b to charge with 9.6 kW.

Through this, the electric vehicle charging system 100 may support 240V 19.2 kW G2V.

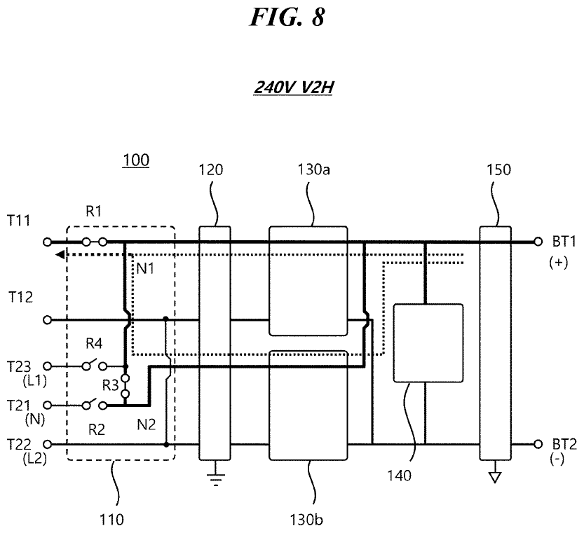

FIG. 8 is a view showing an electric vehicle charging system according to one embodiment that is performing V2H using a plurality of on-board chargers.

Referring to FIG. 8, the first relay R1 in the relay box 110 may be turned on, the second relay R2 may be turned off, the third relay R3 may be turned on, and the fourth relay R4 may be turned off. Depending on the on/off status of these relays, the power flowing through the first on-board charger 130a and the power flowing through the second on-board charger 130b may be delivered to the first AC power first terminal T11.

The control part may run the first on-board charger 130a and the second on-board charger 130b in the discharging mode. The control part may transmit a command value for discharging power, i.e., a voltage command value or a current command value, to the first on-board charger 130a and the second on-board charger 130b. For example, the control part may transmit a command value to the first on-board charger 130a to discharge at 240V and transmit a command value to the second on-board charger 130b to discharge at a certain current level.

In this case, a home power grid may be connected to the first AC power first terminal T11 and the first AC power second terminal T12. Through this, the electric vehicle charging system 100 may support V2H up to 19.2 kW at 240V.

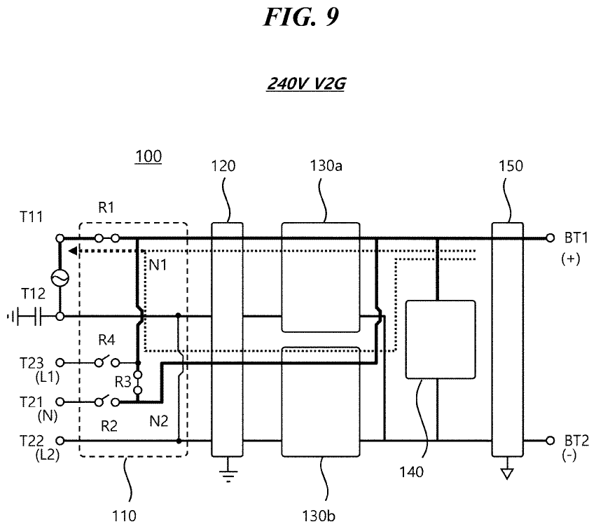

FIG. 9 is a view showing an electric vehicle charging system according to one embodiment that is performing V2G using a plurality of on-board chargers.

Referring to FIG. 9, the first relay R1 in the relay box 110 may be turned on, the second relay R2 may be turned off, the third relay R3 may be turned on, and the fourth relay R4 may be turned off. Depending on the on/off status of these relays, the power flowing through the first on-board charger 130a and the power flowing through the second on-board charger 130b may be delivered to the first AC power first terminal T11.

The control part may run the first on-board charger 130a and the second on-board charger 130b in the discharging mode. The control part may transmit a command value for discharging power, i.e., a voltage command value or a current command value, to the first on-board charger 130a and the second on-board charger 130b. For example, the control part may transmit a command value to the first on-board charger 130a to discharge at 240V and transmit a command value to the second on-board charger 130b to discharge at a certain current level.

In this case, a grid, i.e., a commercial power grid, may be connected to the first AC power first terminal T11 and the first AC power second terminal T12. Through this, the electric vehicle charging system 100 may support V2G up to 19.2 kW at 240V.

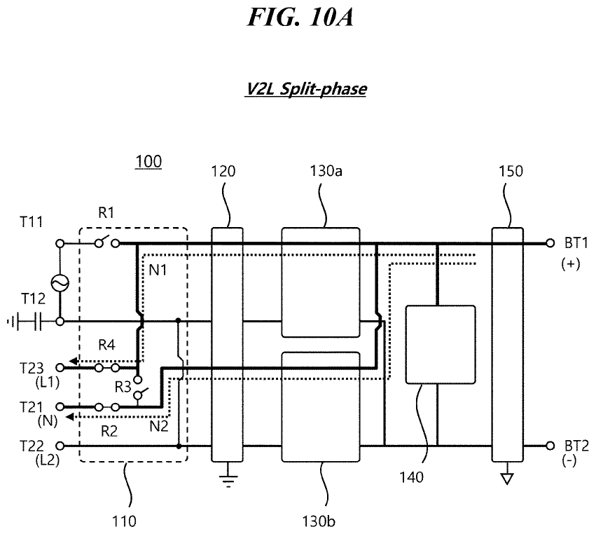

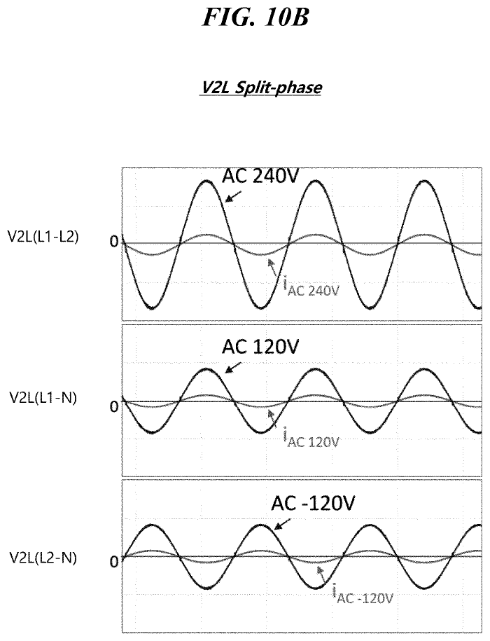

FIG. 10A is a view showing an electric vehicle charging system according to one embodiment that is performing a V2L split-phase mode. FIG. 10B is a view showing an output waveform of an AC power terminal in the mode of FIG. 10A.

Referring to FIGS. 10A and 10B, the first relay R1 in the relay box 110 may be turned off, the second relay R2 may be turned on, the third relay R3 may be turned off, and the fourth relay R4 may be turned on. Depending on the on/off status of these relays, the power flowing through the first on-board charger 130a may be delivered to the second AC power third terminal T23, and the power flowing through the second on-board charger 130b may be delivered to the second AC power first terminal T21.

The control part may run the first on-board charger 130a in the discharging mode. The control part may transmit an output voltage command value for discharging power to the first on-board charger 130a. For example, the control part may transmit an output voltage command value corresponding to 240V.

The control part may run the second on-board charger 130b in the discharging mode. The control part may transmit an output voltage command value for discharging power to the second on-board charger 130b. For example, the control part may transmit an output voltage command value corresponding to 120V.

A load using split-phase power may be connected to the second AC power terminal group T21, T22, and T23. In this case, the second AC power third terminal T23 may function as L1 phase, the second AC power first terminal T21 may function as N phase, and the second AC power second terminal T22 may function as L2 phase.

The first on-board charger 130a may convert power so that 240V AC power is formed between the second AC power third terminal T23 (L1 phase) and the second AC power second terminal T22 (L2 phase). Also, the second on-board charger 130b may convert power so that 120V AC power is formed between the second AC power third terminal T23 (L1 phase) and the second AC power second terminal T22 (L2 phase). In this case, as shown in FIG. 10B, a 180-degree phase difference may occur between the power formed by the first on-board charger 130a and the power formed by the second on-board charger 130b, and such a phase difference may be formed by a command value from the control part.

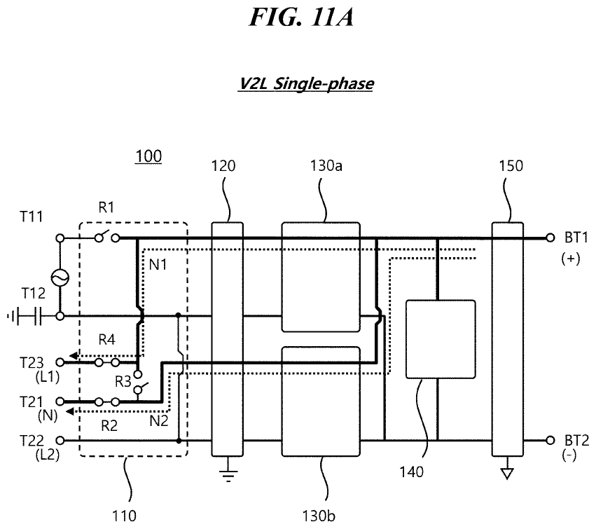

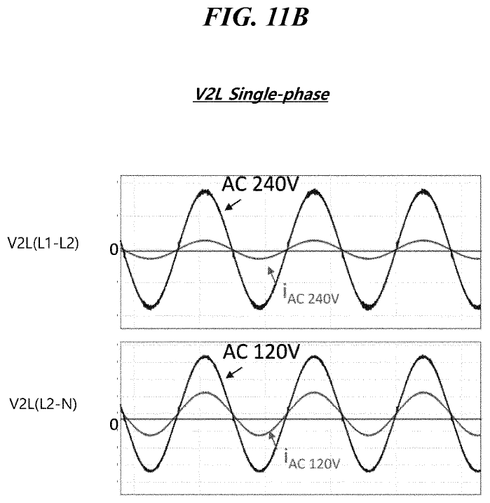

FIG. 11A is a view showing an electric vehicle charging system according to one embodiment that is performing a V2L single-phase dual-voltage power mode. FIG. 11B is a view showing an output waveform of an AC power terminal in the mode of FIG. 11A.

Referring to FIGS. 11A and 11B, the first relay R1 in the relay box 110 may be turned off, the second relay R2 may be turned on, the third relay R3 may be turned off, and the fourth relay R4 may be turned on. Depending on the on/off status of these relays, the power flowing through the first on-board charger 130a may be delivered to the second AC power third terminal T23, and the power flowing through the second on-board charger 130b may be delivered to the second AC power first terminal T21.

The control part may run the first on-board charger 130a in the discharging mode. The control part may transmit an output voltage command value for discharging power to the first on-board charger 130a. For example, the control part may transmit an output voltage command value corresponding to 240V.

The control part may run the second on-board charger 130b in the discharging mode. The control part may transmit an output voltage command value for discharging power to the second on-board charger 130b. For example, the control part may transmit an output voltage command value corresponding to 120V.

A load using single-phase dual-voltage power may be connected to the second AC power terminal group T21, T22, and T23. In this case, the second AC power third terminal T23 may function as L1 phase, the second AC power first terminal T21 may function as N phase, and the second AC power second terminal T22 may function as L2 phase.

The first on-board charger 130a may convert power so that 240V AC power is formed between the second AC power third terminal T23 (L1 phase) and the second AC power second terminal T22 (L2 phase). Also, the second on-board charger 130b may convert power so that 120V AC power is formed between the second AC power first terminal T21 (N phase) and the second AC power second terminal T22 (L2 phase). In this case, as shown in FIG. 11B, the power formed by the first on-board charger 130a and the power formed by the second on-board charger 130b may have the same phase but differ in voltage level, and such a voltage level difference may be formed by a command value from the control part.

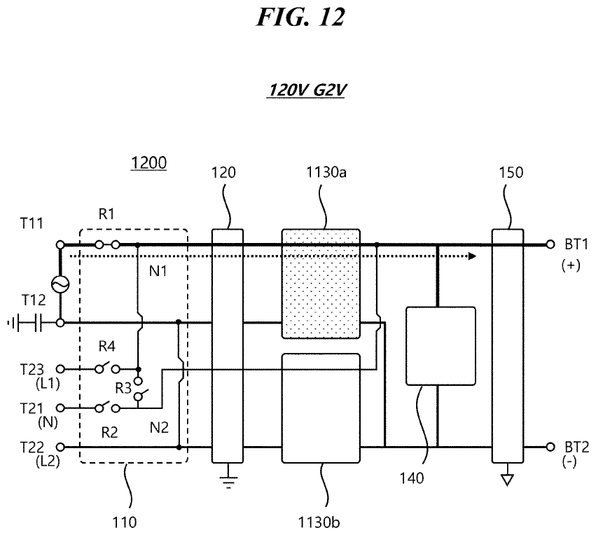

FIG. 12 is a view showing an electric vehicle charging system according to another embodiment that is performing G2V.

Referring to FIG. 12, the electric vehicle charging system 100 may include a relay box 110, an input filter circuit 120, a plurality of on-board chargers 1130a and 1130b, a power decoupling circuit 140, an output filter circuit 150, and a control part 160.

In one embodiment, an example was described in which the rated power of the first on-board charger and the rated power of the second on-board charger are substantially the same. In another embodiment, the rated power of the first on-board charger 1130a and the rated power of the second on-board charger 1130b may be different from each other. In yet another embodiment, the rated power of the first on-board charger 1130a may be higher than the rated power of the second on-board charger 1130b. For example, the rated power of the first on-board charger 1130a may be 19.2 kW, and the rated power of the second on-board charger 1130b may be 9.6 kW.

In the example of FIG. 12, the first relay R1 may be turned on, the second relay R2 may be turned off, the third relay R3 may be turned off, and the fourth relay R4 may be turned off. Depending on the on/off status of these relays, the power flowing through the first on-board charger 1130a may flow to the first AC power terminal group T11 and T12.

The control part may control the first on-board charger 1130a in the charging mode and turn off the second on-board charger 1130b. Accordingly, the first on-board charger 1130a may charge the electric vehicle battery with a rated power of 19.2 kW. In this case, the power connected to the first AC power terminal group T11 and T12 may be 120V grid power, and the electric vehicle charging system 1200 may support 120V G2V.

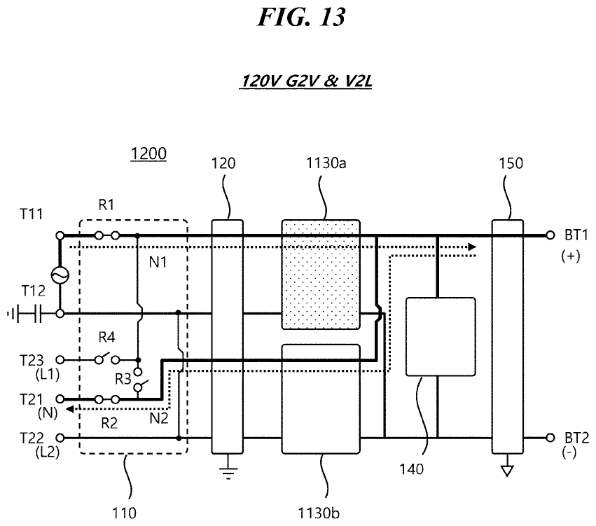

FIG. 13 is a view showing an electric vehicle charging system according to another embodiment that is performing G2V and V2L simultaneously.

Referring to FIG. 13, the first relay R1 may be turned on, the second relay R2 may be turned on, the third relay R3 may be turned off, and the fourth relay R4 may be turned off. Depending on the on/off status of these relays, the power flowing through the first on-board charger 1130a may flow to the first AC power terminal group T11 and T12, and the power flowing through the second on-board charger 1130b may flow to the second AC power terminal group T21, T22, and T23.

The control part may control the first on-board charger 1130a in the charging mode and control the second on-board charger 1130b in the discharging mode. Accordingly, the first on-board charger 1130a may charge the electric vehicle battery with a rated power of 19.2 kW. Also, the second on-board charger 1130b may supply power to the load. Therefore, 120V G2V and V2L may be simultaneously performed. In some cases, the second on-board charger 1130b may output 240V, in which case 120V G2V and 240V V2L may be performed simultaneously.

As described above, according to the present disclosure, various operation modes such as V2G, V2H, and V2L can be reliably performed while an electric vehicle is performing charging, thereby maximizing the utilization of the vehicle's battery. Furthermore, according to the present disclosure, the output of voltages of 120V and 240V can be supported concurrently without an additional DC-AC inverter or complex hardware, thereby reducing system complexity and lowering manufacturing and operating costs. In addition, according to the present disclosure, a single integrated structure is provided which is capable of flexibly switching between charging and discharging and reliably handling high power, thereby enhancing system reliability and efficiency.

The terms “include,” “comprise,” or “have” as used herein, unless otherwise specifically stated, imply that the corresponding component may be included, and therefore should be interpreted as including other components rather than excluding other components. All terms, including technical or scientific terms, unless otherwise defined, have the same meaning as commonly understood by a person of ordinary skill in the art to which this disclosure pertains. Commonly used terms, such as terms defined in a dictionary, should be interpreted as being consistent with their contextual meaning in the relevant art, and shall not be interpreted in an idealistic or overly formal sense, unless expressly defined in the present disclosure.

The above description is merely an illustrative description of the technical idea of the present disclosure, and those skilled in the art will appreciate that various modifications and variations may be made without departing from the essential characteristics of the present disclosure. Accordingly, the embodiments disclosed in the present disclosure are not intended to limit the technical idea of the present disclosure but to explain it, and the scope of the technical idea of the present disclosure is not limited by these embodiments. The protection scope of the present disclosure should be interpreted by the following claims, and all technical ideas within a scope equivalent thereto should be interpreted as being included in the scope of the rights of the present disclosure.

What is claimed is:

1. An electric vehicle charging system comprising:
a relay box with a plurality of AC power terminals disposed therein, the AC power terminals having power input/output pathways that are changed depending on the on/off status of built-in relays;
a plurality of on-board chargers that support bidirectional power conversion between an electric vehicle battery and the relay box; and
a control part that supports charging and V2X concurrently through the AC power terminals by controlling the direction of power conversion of each on-board charger and the on/off status of the relays.

2. The electric vehicle charging system of claim 1, wherein a plurality of AC power terminal groups each including at least two AC power terminals are formed in the relay box,
wherein the control part controls connections between the plurality of AC power terminal groups and the plurality of on-board chargers by controlling the on/off status of the relays.

3. The electric vehicle charging system of claim 2, wherein, in a first combination mode, the electric vehicle battery is charged with AC power via a first on-board charger, the AC power being inputted through a first AC power terminal group, and the electric vehicle battery's power is discharged to a second AC power terminal group via a second on-board charger.

4. The electric vehicle charging system of claim 2, wherein, in a second combination mode, a first on-board charger is connected to a first AC power terminal group, a second on-board charger is connected to a second AC power terminal group, and the first AC power terminal group and the second AC power terminal group each operate in one of V2G, V2L, and V2H modes.

5. The electric vehicle charging system of claim 4, wherein the first on-board charger and the second on-board charger control the voltage outputted through each AC power terminal group to differ in voltage level.

6. The electric vehicle charging system of claim 2, wherein, in a third combination mode, the plurality of on-board chargers simultaneously charge the electric vehicle battery while operating in parallel, by converting the power inputted into one AC power terminal group.

7. The electric vehicle charging system of claim 2, wherein, in a split-phase mode, one AC power terminal group includes three AC power terminals, one AC power discharged via one on-board charger is outputted to an AC power first terminal and an AC power second terminal, another AC power discharged via another on-board charger is outputted to an AC power third terminal and an AC power second terminal, and the one AC power and the another AC power are 180 degrees out of phase.

8. The electric vehicle charging system of claim 2, wherein, in a single-phase dual-voltage power mode, one AC power terminal group includes three AC power terminals, one AC power discharged via one on-board charger is outputted to an AC power first terminal and an AC power second terminal, another AC power discharged via another on-board charger is outputted to an AC power third terminal and an AC power second terminal, and the voltage level of the another AC power is twice the voltage level of the one AC power.

9. The electric vehicle charging system of claim 2, wherein a first AC power terminal group includes a first AC power first terminal and a first AC power second terminal, and a second AC power terminal group includes a second AC power first terminal and a second AC power second terminal,
wherein the first AC power second terminal and the second AC power second terminal are connected to a common terminal, and a first relay is positioned between the first AC power first terminal and an input node of a first on-board charger, a second relay is positioned between the second AC power first terminal and an input node of a second on-board charger, and a third relay is positioned between the input node of the first on-board charger and the input node of the second on-board charger.

10. The electric vehicle charging system of claim 9, wherein the second AC power terminal group further includes a second AC power third terminal, and a fourth relay is positioned between the second AC power third terminal and the input node of the first on-board charger.

11. The electric vehicle charging system of claim 1, wherein a power decoupling circuit is positioned between the plurality of on-board chargers and the electric vehicle battery, an input filter circuit is positioned between the relay box and the plurality of on-board chargers, and an output filter circuit is positioned between the plurality of on-board chargers and the electric vehicle battery.

12. The electric vehicle charging system of claim 1, wherein the rated power of each on-board charger is substantially the same.

13. An electric vehicle charging system comprising:
a relay box with a plurality of AC power terminals disposed therein, the AC power terminals having power input/output pathways that are changed depending on the on/off status of built-in relays;
a first on-board charger that supports bidirectional power conversion between an electric vehicle battery and the relay box;
a second on-board charger that supports bidirectional power conversion between the electric vehicle battery and the relay box and has a lower rated power than the first on-board charger; and
a control part that supports charging and V2X concurrently through the AC power terminals by controlling the direction of power conversion of each on-board charger and the on/off status of the relays.

14. The electric vehicle charging system of claim 13, wherein a plurality of AC power terminal groups each including at least two AC power terminals are formed in the relay box,
wherein the control part controls connections between the plurality of AC power terminal groups and the plurality of on-board chargers by controlling the on/off status of the relays.

15. The electric vehicle charging system of claim 13, wherein the first on-board charger operates in a charging mode, and the second on-board charger operates in a discharging mode,
wherein the AC power supplied to the first on-board charger and the AC power outputted by the second on-board charger are controlled to differ in voltage level.
